(19) United States
(12) Patent Application Publication
(10) Pub. No.: US 2011/0049090 A1
(43) Pub. Date: Mar. 3, 2011

(54) METHOD OF MANUFACTURING MAGNETIC RECORDING MEDIUM

(75) Inventors: Yoshiyuki KAMATA, Tokyo (JP); Hiromi YUASA, Kawasaki-shi (JP); Shuichi MURAKAMI, Fuchu-shi (JP); Hideaki FUKUZAWA, Kawasaki-shi (JP); Michiko HARA, Yokohama-shi (JP); Yoshihiko FUJI, Kawasaki-shi (JP); Masatoshi SAKURAI, Tokyo (JP)

(73) Assignee: KABUSHIKI KAISHA TOSHIBA, Tokyo (JP)

(21) Appl. No.: 12/872,820

(22) Filed: Aug. 31, 2010

(30) Foreign Application Priority Data
Aug. 31, 2009 (JP) 2009-201037

(51) Int. Cl. G11B 5/84

(52) U.S. Cl. 216/22

(57) ABSTRACT

According to one embodiment, a method of manufacturing a magnetic recording medium includes forming a magnetic recording layer, an etching protection layer, and an adhesion layer on a substrate, applying a resist on the adhesion layer, transferring patterns of protrusions and recesses on the resist by imprinting to form a resist pattern, patterning the adhesion layer by using the resist pattern as a mask, patterning the etching protection layer by using the resist pattern as a mask, etching the magnetic recording layer by using patterns of the adhesion layer and the etching protection layer as masks to form patterns of protrusions and recesses of the magnetic recording layer and removing the pattern of the adhesion layer, stripping the pattern of the etching protection layer, and exposing the patterns of protrusions and recesses of the magnetic recording layer to a non-ionized reducing gas.

### CROSS-REFERENCE TO RELATED APPLICATIONS

This application is based upon and claims the benefit of priority from Japanese Patent Application No. 2009-201037, filed Aug. 31, 2009; the entire contents of which are incorporated herein by reference.

### FIELD

Embodiments described herein relate generally to a method of manufacturing a magnetic recording medium.

### BACKGROUND

Recently, in a magnetic recording medium to be installed in hard disk drives (HDDs), there is an increasing problem of disturbance of enhancement in track density due to interference between adjacent tracks. In particular, a serious technical subject is reduction of write blurring due to fringe effect of a magnetic field from a write head.

To solve such a problem, a discrete track recording medium (DTR medium) has been proposed in which recording tracks are physically separated from each other. Since the DTR medium can reduce a side-erase phenomenon of erasing information of the adjacent track in writing and a side-read phenomenon of reading out information of the adjacent track in reading, it can increase the track density. Therefore, the DTR medium is promising as a high-density magnetic recording medium. Also, a bit patterned medium (BPM) has been proposed in which read and write are performed for a single magnetic dot as a single recording cell have been proposed. Therefore, the DTR medium is expected as a magnetic recording medium that is capable of providing a high recording density. Further, a bit patterned medium (BPM) that performs read and write by using a single magnetic dot as a single recording bit is expected as a next-generation technology that is capable of realizing a higher density. Hereinafter, the DTR medium and BPM are collectively referred to as a patterned medium.

A method of manufacturing a patterned medium comprises, for example, etching a magnetic recording layer using a mask layer of carbon as a mask, and then removing the mask layer. In order to etch the magnetic recording medium, ion beam etching is performed by producing plasma from an Ar gas or the like in a vacuum and subjecting the produced ions to electric field acceleration or reactive ion etching (RIE) is performed by producing plasma from a reactive gas. For the removal of the mask layer of carbon, RIE is performed by producing plasma from an oxygen gas.

Since the method of manufacturing a patterned medium comprises many steps, it is preferable to prevent deterioration of magnetic characteristics by suppressing process damage as much as possible in each of the steps. In order to suppress the process damage in the ion beam etching, acceleration of the ions may be reduced. However, since the reduction in acceleration reducing an etching rate, it is undesirable from the viewpoint of mass production. Since a surface of a sample to be processed is directly exposed to the plasma in RIE, it is essentially difficult to suppress the process damage.

Conventionally, a method of manufacturing a patterned medium has been proposed that prevents deterioration of magnetic characteristics by adding a step of removing an oxidizing gas after processing a magnetic recording layer (Japanese Patent No. 4191096). In the method, a cleaning gas containing hydrogen is made into plasma to perform dry cleaning, thereby removing the oxidizing gas.

However, the method has two problems. The first problem is that the step of dry cleaning by producing plasma from the hydrogen gas in itself causes damage to the sample. Since it is generally necessary to apply high energy of from several hundreds to a several thousands of watts for producing plasma from a gas, damage by heat is concerned, and the ionized gas collides with the sample surface to cause damage. The second problem is that it is considerably difficult to produce plasma from a light gas such as hydrogen. Unstable plasma makes the effect of the dry cleaning unstable, which considerably deteriorates process tolerance. In order to make the hydrogen gas into stable plasma, it is possible to increase power to be applied, but the increase in power further enhances damages caused by heat and hydrogen ion collision. In order to stabilize plasma, it is possible to mix a nitrogen gas or argon gas with the hydrogen gas. Since the nitrogen gas or the argon gas is made into plasma, however, it is difficult to avoid damages caused by their ions.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a plan view showing a discrete track recording medium according to one embodiment along a circumferential direction;

FIG. 2 is a plan view showing a bit patterned medium according to another embodiment along a circumferential direction;

FIGS. 3A, 3B, 3C, 3D, 3E, 3F, 3G, 3H, and 3I are cross-sectional views showing a method of manufacturing a magnetic recording medium according to an embodiment;

FIG. 4 is a block diagram showing a manufacturing apparatus for carrying out the method of an embodiment;

FIG. 5A is a schematic view showing a plan view TEM image of a boundary region between a magnetic recording layer and a nonmagnetic layer and FIG. 5B is a perspective view showing crystal grains contained in the nonmagnetic layer;

FIG. 6A and FIG. 6B are cross-sectional views each showing a surface state of the magnetic recording layer in Example 1;

FIG. 7 is a graph showing a relationship between a process pressure and a process time in Example 2; and

FIG. 8A and FIG. 8B are plan views each showing a shape of a recording bit, which is observed by MFM, of BPM manufactured in Example 6.

### DETAILED DESCRIPTION

Various embodiments will be described hereinafter with reference to the accompanying drawings.

In general, according to one embodiment, there is provided a method of manufacturing a magnetic recording medium, comprising: forming a magnetic recording layer, an etching protection layer, and an adhesion layer on a substrate; applying a resist on the adhesion layer; transferring patterns of protrusions and recesses on the resist by imprinting to form a resist pattern; patterning the adhesion layer by using the resist pattern as a mask; patterning the etching protection layer by using the resist pattern as a mask; etching the magnetic recording layer by using patterns of the adhesion layer and the etching protection layer as masks to form patterns of protrusions and recesses of the magnetic recording layer and removing the pattern of the adhesion layer; stripping the pattern of the etching protection layer; and exposing the patterns of protrusions and recesses of the magnetic recording layer to a non-ionized reducing gas.

As described above, in order to remove oxidizing gas after processing on a magnetic recording medium to prevent deterioration of magnetic characteristics, it has conventionally been considered that it is necessary to use plasma produced from hydrogen gas. In contrast, we found that it is possible to eliminate process damages, which are previously caused on patterns of protrusions and recesses of the magnetic recording layer, by using a non-ionized reducing gas that is not made into plasma. Further, using the non-ionized reducing gas does not cause damages on the sample, which are caused by heat or collision of ionized gas with a sample surface like the case of using the plasma process. Consequently, it is possible to prevent deterioration of magnetic characteristics of the magnetic recording medium.

In the embodiments, examples of the reducing gas include hydrogen (H₂), a forming gas, i.e., a mixture gas of N₂ and H₂, which is a gas obtained by diluting H₂ with N₂ so as to be the explosion limit or less and generally having a H₂ concentration of 5% or less, ammonium (NH₃), and carbon monoxide (CO).

Hereinafter, embodiments will be described with reference to the drawings.

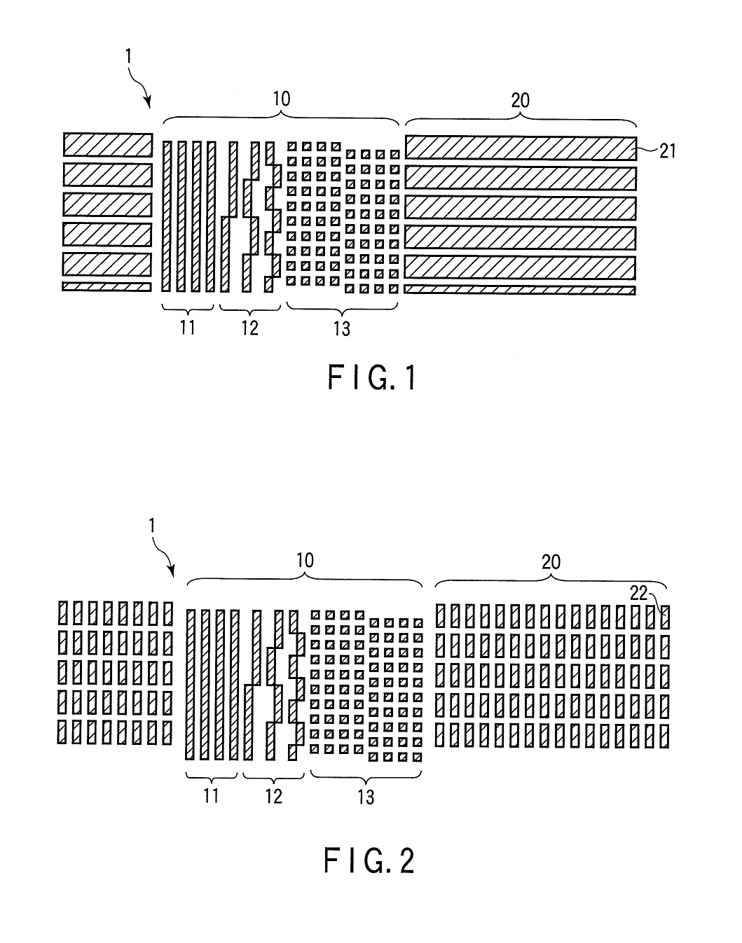

FIG. 1 is a plan view showing a discrete track recording medium (DTR medium) 1 along a circumferential direction. As shown in FIG. 1, servo regions 10 and data regions 20 are alternately formed along the circumferential direction of the medium 1. The servo region 10 includes a preamble section 11, an address section 12, and a burst section 13. The data region 20 includes discrete tracks 21 that are separated from one another.

FIG. 2 is a plan view showing a bit patterned medium (BPM) 2 along a circumferential direction. As shown in FIG. 2, servo regions 10 have a similar structure as FIG. 1. Data regions 20 include recording bits 22 that are separated from one another.

In the embodiments, a master plate on which patterns corresponding to the recording tracks in the data regions of the DTR medium shown in FIG. 1 or to the recording bits in the data regions of BPM shown in FIG. 2 and patterns corresponding to information of the servo regions are formed as protrusions and recesses, a Ni stamper, and UV imprint mold (resin stamper) are manufactured.

First, a UV imprint mold (a resin stamper) is manufactured as described below. A 6-inch Si substrate is spin-coated with an electron beam (EB) resist (ZEP-520A; manufactured by Zeon Corporation), and then pre-baked at 200° C. for 3 minutes, on which a resist layer having a thickness of about 50 nm is formed. The patterns shown in FIG. 1 are directly written on the resist on the Si substrate by EB lithography. The resist is immersed in a developing liquid (ZED-50N; manufactured by Zeon Corporation) and developed to manufacture a master plate. A Ni conductive film is formed on the master plate by sputtering. The master plate is immersed in a nickel sulfamate solution (NS-160; manufactured by Showa Chemical Industry Co., Ltd.) and electroformed for 90 minutes to deposit a Ni layer. After the electroforming, the Ni layer is peeled off, from which the EB resist adhered to the surface is removed by oxygen RIE, to provide a Ni stamper. The Ni stamper is set to an injection molding machine to produce a resin stamper by injection molding. The molding material to be used includes ZEONOR 1060R which is a cyclic olefin polymer manufactured by Zeon Corporation, and AD5503 which is polycarbonate manufactured by Teijin Chemicals.

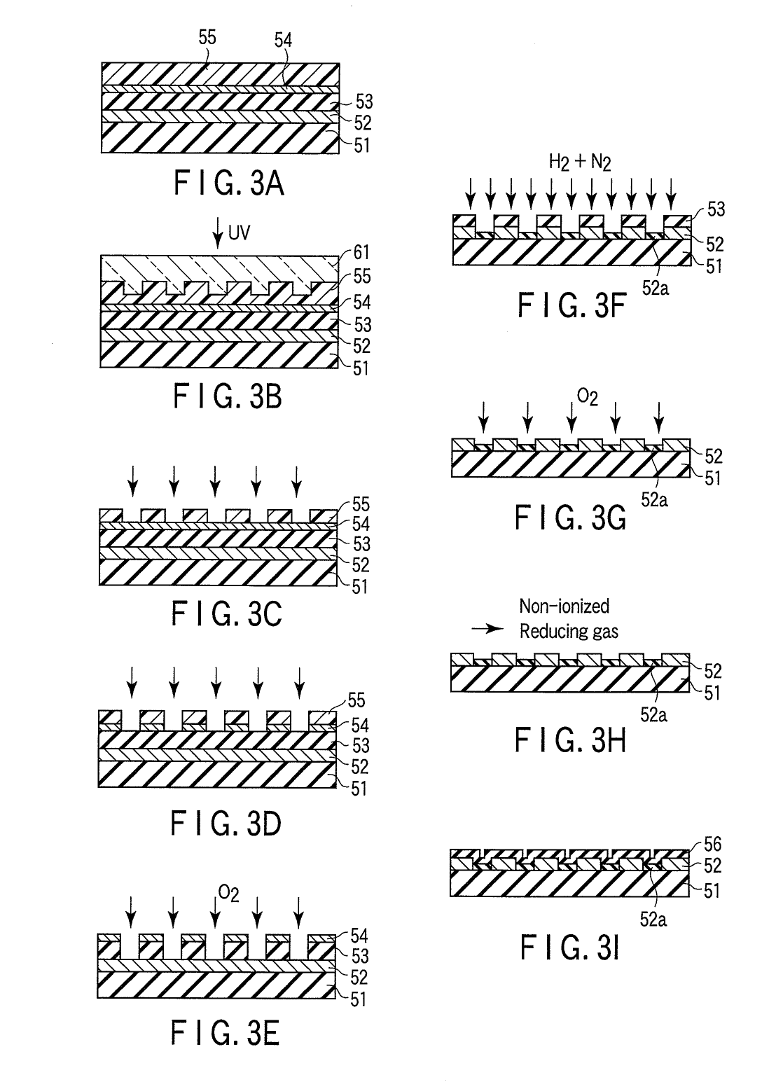

Next, a method of manufacturing a magnetic recording medium (a patterned medium) according to an embodiment will be described with reference to FIGS. 3A, 3B, 3C, 3D, 3E, 3F, 3G, 3H, and 3I.

As shown in FIG. 3A, on a glass substrate 51, a soft magnetic underlayer of CoZrNb with a thickness of 120 nm, an orientation controlling underlayer of Ru with a thickness of 20 nm, a ferromagnetic layer 52 of CoCrPt—SiO₂ with a thickness of 15 nm, an etching protection layer 53 of carbon (C) with a thickness of 15 nm, and an adhesion layer 54 of Cu with a thickness of 3 to 5 nm are sequentially formed. Here, the soft magnetic underlayer and the orientation controlling layer are not shown for brevity. The adhesion layer 54 has a function of adhering a UV curable resin applied thereto. Examples of a material for the adhesion layer include Cu, CoPt, Al, NiTa, Ta, Ti, Si, Cr, and NiNbZrTi.

A resist 55 of a UV curable resin is applied to the adhesion layer 54 by spin-coating to a thickness of 50 nm. The UV curable resin contains a monomer, an oligomer, and a polymerization initiator. Examples of the UV curable resin include those containing 85% of isobornylacrylate (IBOA) as the monomer, 10% of polyurethanediacrylate (PUDA) as the oligomer, and 5% of DAROCUR 1173 as the polymerization initiator.

As shown in FIG. 3B, a resin stamper 61 is pressed to the resist 55 and the resist 55 is cured by irradiation with an ultraviolet ray through the resin stamper 61 to perform UV imprinting, thereby transferring patterns of protrusions and recesses of the resin stamper 61 to the resist 55. After that, the resin stamper 61 is removed.

As shown in FIG. 3C, imprint residues remaining in the recesses of the resist 55 are removed by oxygen plasma or an Ar ion beam to expose a part of a surface of the adhesion layer 54. For example, using an RIE system, oxygen is introduced to set a chamber pressure to 2 mTorr, oxygen plasma is generated under a power of 100 W, and etching is performed for 15 seconds.

As shown in FIG. 3D, the adhesion layer 54 is etched by using the pattern of the resist 55 as a mask to form a pattern of the adhesion layer 54 and a part of a surface of the etching protective film 53 is exposed. In the case where Cu is used for the adhesion layer, the ion beam etching with Ar gas is performed. In the case where Si is used for the adhesion layer, RIE with a fluorine-based gas such as CF₄ and CHF₃ is performed. Since it is possible to employ RIE with fluorine-based gas for the UV curable resin, RIE with fluorine-based gas for the removal of the imprint residues and the etching of the adhesion layer can be performed at once in the case where the adhesion layer is Si.

As shown in FIG. 3E, the etching protective film 53 is etched with oxygen plasma by using the patterns of the resist 55 and the adhesion layer 54 as masks to form a pattern of the etching protective film 53, and a part of a surface of the magnetic recording layer 52 is exposed. Also, the pattern of the resist 55 is removed simultaneously with the etching on the etching protective film 53. For example, using an RIE system, oxygen is introduced to set a chamber pressure to 2 mTorr, oxygen plasma is generated under a power of 100 W, and etching is performed for 30 seconds.

As shown in FIG. 3F, the magnetic recording layer 52 is ion-beam etched with He+N₂ having a mixing ratio of 1:1 by using the pattern of the etching protective film 53 as a mask. For example, using an ECR (electronic cyclotron resonance), etching is performed for 20 seconds under a microwave power of 800 W and an acceleration voltage of 1000 V to form recesses with a depth of 10 nm on the magnetic recording layer 52 with a thickness of 15 nm. Here, a nonmagnetic layer 52a of a material prepared by deactivating magnetism of the magnetic recording layer by exposure to the He+N₂ mixture gas plasma and having a thickness of 5 nm is formed at the bottoms of the recesses of the magnetic recording layer 52. Also, the pattern of the adhesion layer (e.g., Cu) is removed simultaneously with the etching of the magnetic recording layer 52. The reason for removing the adhesion layer is that it is impossible to strip off the etching protective film in the subsequent step where the pattern of the adhesion layer is remained.

As shown in FIG. 3G, the pattern of the etching protective film 53 is stripped off by oxygen plasma. For example, using an RIE system, oxygen is introduced to set a chamber pressure to 100 mTorr, oxygen plasma is generated under a power of 100 W, and etching is performed for 30 seconds.

As shown in FIG. 3H, the patterns of protrusions and recesses of the magnetic recording layer 52 are exposed to a non-ionized reducing gas. For example, the sample is conveyed into a vacuum chamber that is maintained to 1.0×10⁻⁴ Pa or less and retained for 30 seconds in a state where a hydrogen gas is flowed to the chamber at a flow rate of 100 sccm and a chamber pressure is maintained to 1 Pa. Here, the hydrogen gas is not made into plasma.

By the step of FIG. 3H, the sample has been exposed to the oxygen plasma in FIG. 3C, to the Ar ion beam in FIG. 3D, to the oxygen plasma in FIG. 3E, to the He+N₂ mixture gas plasma in FIG. 3F, and to the oxygen plasma in FIG. 3G. Exposing the sample to the non-ionized reducing gas in FIG. 3H can eliminate process damages accumulated during the steps. In particular, it is possible to reduce and remove an oxygen film formed on a surface of the sample due to the exposure to oxygen plasma.

As shown in FIG. 3I, a surface protective film 56 of carbon with a thickness of 4 nm is formed on the entire surface by CVD (chemical vapor deposition). A lubricant (not shown) is applied to the surface protective film 56 to manufacture the patterned medium according to one embodiment.

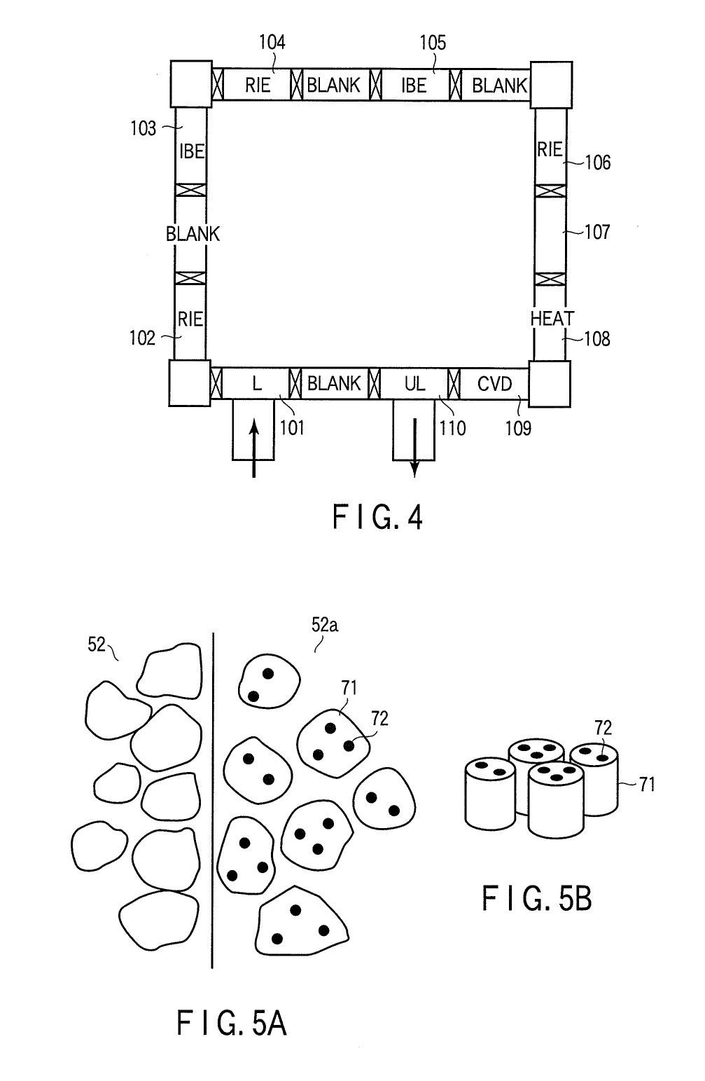

FIG. 4 shows an example of a manufacturing apparatus to be used for the manufacture of the patterned medium according to one embodiment. After the UV imprint step shown in FIG. 3B, the sample is loaded from the load chamber 101. The sample is placed on a carrier to be conveyed to each of chambers in vacuum and undergoes a predetermined process. In the RIE chamber 102, removal of resist residues with oxygen plasma in FIG. 3C is performed. In the IBE chamber 103, etching of the adhesion layer with Ar ion beam in FIG. 3D is performed. In the RIE chamber 104, etching of the etching protective film with oxygen plasma in FIG. 3E is performed. In the IBE chamber 105, etching and magnetism deactivation of the magnetic recording layer with He+N₂ mixture gas plasma in FIG. 3F is performed. In the RIE chamber 106, removal of the pattern of the etching protective film with oxygen plasma in FIG. 3G is performed. In the gas flow chamber 107, elimination of the process damages with non-ionized reducing gas in FIG. 3H is performed. Since it is not required to generate plasma in the gas flow chamber 107, the gas flow chamber 107 is provided only with a mass flow controller for gas introduction and a turbo pump for evacuation. In the heat chamber 108, preliminary heating of the sample is performed before the sample is conveyed to the subsequent CVD chamber. In the CVD chamber 109, a surface protective film is deposited. The sample that has undergone the above steps is unloaded from the unload chamber 110. Blank chambers are provided between the adjacent chambers in order to prevent the process gas to flow from one of the chambers into the adjacent chamber.

In an HDD apparatus in which the patterned medium and the read/write head are incorporated, the read/write head operates with a flying height of about 10 nm. In order to stably maintain the flying height of the read/write head, it is desirable that the protrusions and recesses of the surface of the patterned medium is 10 nm or less. Therefore, embedding of a nonmagnetic material into the recesses between the physically separated recording tracks or recording bits and surface flattening by etch-back have been practiced. The embedding of the nonmagnetic material is performed by bias sputtering, for example. Since bias power is directly applied to the patterned medium in the bias sputtering, there is a risk that damages by heat are caused to the sample. The flattening by etch-back is performed by ion beam etching, for example. Thus, when the steps of the nonmagnetic material embedding and the flattening are added, further process damages may be accumulated.

In contrast, as a result of forming the recesses having the depth of 10 nm, for example, by the ion beam etching with He+N₂ mixture gas in such a manner as to remain a part of the thickness of the magnetic recording layer with the thickness of 15 nm and forming the nonmagnetic layer with the thickness of 5 nm by the magnetism deactivation of the part of the magnetic recording layer remaining in the recesses as in the above embodiment, a magnetic depth of the recesses is 15 nm though the physical depth of the recesses is 10 nm. Therefore, it is possible to manufacture the patterned medium that is capable of suppressing the side erase and the side read while ensuring the flying characteristics of the read/write head without performing the embedding and the flattening of the nonmagnetic material.

However, it has been found that film properties of the carbon films formed on the magnetic recording layer and the nonmagnetic layer are different from each other due to the difference in surface characteristics of the magnetic recording layer that is not exposed to the He+N₂ mixture gas ion beam and the nonmagnetic layer formed by the magnetism deactivation by the exposure to He+N₂ mixture gas ion beam.

The carbon film formed on the magnetic recording layer by CVD and the carbon film formed on the nonmagnetic layer by the magnetism deactivation by the exposure to He+N₂ mixture gas ion beam were compared to each other by Raman spectroscopy. From the Raman spectra, a ratio Id/Ig between a peak intensity Id of a D-band near 1390 cm⁻¹ and a peak intensity Ig of a G-band near 1555 cm⁻¹ was determined. Since the D-band is a peak that is attributable to disturbance in structure, a large Id/Ig indicates that the structure of the carbon film is disturbed, and that a density of the carbon film is low.

As a result, it was confirmed that the carbon film formed on the nonmagnetic layer has a slightly larger Id/Ig as compared to the carbon film formed on the magnetic recording layer. This means that the density of the carbon film on the nonmagnetic layer formed by magnetism deactivation by the exposure to He+N₂ mixture gas ion beam is lower, and that the carbon film is inferior in durability. It should be noted that, since the carbon film formed on the nonmagnetic layer at the recesses of the magnetic recoding layer does not directly contact with the read/write head, no trouble is considered to occur in normal use. However, from the viewpoint of ensuring long-term reliability under high-temperature, high-humidity environment, it is desirable that the carbon film formed on the nonmagnetic layer has high density and is robust.

It was found that when the nonmagnetic layer is formed by He+N₂ mixture gas ion beam etching and magnetism deactivation of the magnetic recording layer, the sample is exposed to non-ionized hydrogen gas, and then the carbon film is formed as described above in the embodiment, it is possible to provide a good carbon film. It is considered that the good carbon film is provided by the following reasons.

FIG. 5A is a schematic diagram showing a plan view TEM image of a boundary region between the magnetic recording layer that is not exposed to the He+N₂ mixture gas ion beam and the nonmagnetic layer that is exposed to the He+N₂ mixture gas ion beam. FIG. 5B is a perspective view showing crystal grains contained in the nonmagnetic layer. As shown in FIG. 5A and FIG. 5B, the surface of the nonmagnetic layer exposed to the He+N₂ mixture gas ion beam is porous in which pores 72 are formed in columnar grains 71. The nonmagnetic layer that is made porous and therefore increased in surface area is considered to readily absorb hydrogen when exposed to the non-ionized hydrogen gas. When the carbon film is formed by CVD on the nonmagnetic layer that has absorbed hydrogen, a so-called hydrogenated carbon film is formed. The hydrogenated carbon film is known to have high hardness. Therefore, the carbon film formed on the nonmagnetic layer is robust and excellent in long-term reliability in the above embodiment.

Next, preferable materials to be used in the embodiments will be described.

[Substrate]

As the substrate, for example, a glass substrate, Al-based alloy substrate, ceramic substrate, carbon substrate or Si single crystal substrate having an oxide surface may be used. As the glass substrate, amorphous glass or crystallized glass is used. Examples of the amorphous glass include common soda lime glass and aluminosilicate glass. Examples of the crystallized glass include lithium-based crystallized glass. Examples of the ceramic substrate include common aluminum oxide, aluminum nitride or a sintered body containing silicon nitride as a major component and fiber-reinforced materials of these materials. As the substrate, those having a NiP layer on the above metal substrates or nonmetal substrates formed by plating or sputtering may be used.

[Soft Magnetic Underlayer]

The soft magnetic underlayer (SUL) serves a part of such a function of a magnetic head as to pass a recording magnetic field from a single-pole head for magnetizing a perpendicular magnetic recording layer in a horizontal direction and to circulate the magnetic field to the side of the magnetic head, and applies a sharp and sufficient perpendicular magnetic field to the recording layer, thereby improving read/write efficiency. For the soft magnetic underlayer, a material containing Fe, Ni or Co may be used. Examples of such a material may include FeCo-based alloys such as FeCo and FeCoV, FeNi-based alloys such as FeNi, FeNiMo, FeNiCr and FeNiSi, FeAl-based alloys and FeSi-based alloys such as FeAl, FeAlSi, FeAlSiCr, FeAlSiTiRu and FeAlO, FeTa-based alloys such as FeTa, FeTaC and FeTaN and FeZr-based alloys such as FeZrN. Materials having a microcrystalline structure such as FeAlO, FeMgO, FeTaN and FeZrN containing Fe in an amount of 60 at % or more or a granular structure in which fine crystal grains are dispersed in a matrix may also be used. As other materials to be used for the soft magnetic underlayer, Co alloys containing Co and at least one of Zr, Hf, Nb, Ta, Ti and Y may also be used. Such a Co alloy preferably contains 80 at % or more of Co. In the case of such a Co alloy, an amorphous layer is easily formed when it is deposited by sputtering. Because the amorphous soft magnetic material is not provided with crystalline anisotropy, crystal defects and grain boundaries, it exhibits excellent soft magnetism and is capable of reducing medium noise. Preferable examples of the amorphous soft magnetic material may include CoZr-, CoZrNb- and CoZrTa-based alloys.

An underlayer may further be formed beneath the soft magnetic underlayer to improve the crystallinity of the soft magnetic underlayer or to improve the adhesion of the soft magnetic underlayer to the substrate. As the material of such an underlayer, Ti, Ta, W, Cr, Pt, alloys containing these metals or oxides or nitrides of these metals may be used. An intermediate layer made of a nonmagnetic material may be formed between the soft magnetic underlayer and the recording layer. The intermediate layer has two functions including the function to cut the exchange coupling interaction between the soft magnetic underlayer and the recording layer and the function to control the crystallinity of the recording layer. As the material for the intermediate layer Ru, Pt, Pd, W, Ti, Ta, Cr, Si, alloys containing these metals or oxides or nitrides of these metals may be used.

In order to prevent spike noise, the soft magnetic underlayer may be divided into plural layers and Ru layers with a thickness of 0.5 to 1.5 nm are interposed therebetween to attain anti-ferromagnetic coupling. Also, a soft magnetic layer may be exchange-coupled with a pinning layer of a hard magnetic film such as CoCrPt, SmCo or FePt having longitudinal anisotropy or an anti-ferromagnetic film such as IrMn and PtMn. A magnetic film (such as Co) and a nonmagnetic film (such as Pt) may be provided under and on the Ru layer to control exchange coupling force.

[Magnetic Recording Layer]

For the perpendicular magnetic recording layer, a material containing Co as a main component, at least Pt and further an oxide is preferably used. The perpendicular magnetic recording layer may contain Cr if needed. As the oxide, silicon oxide or titanium oxide is particularly preferable. The perpendicular magnetic recording layer preferably has a structure in which magnetic grains, i.e., crystal grains having magnetism, are dispersed in the layer. The magnetic grains preferably have a columnar structure which penetrates the perpendicular magnetic recording layer in the thickness direction. The formation of such a structure improves the orientation and crystallinity of the magnetic grains of the perpendicular magnetic recording layer, with the result that a signal-to-noise ratio (SN ratio) suitable to high-density recording can be provided. The amount of the oxide to be contained is important to provide such a structure.

The content of the oxide in the perpendicular magnetic recording layer is preferably 3 mol % or more and 12 mol % or less and more preferably 5 mol % or more and 10 mol % or less based on the total amount of Co, Cr and Pt. The reason why the content of the oxide in the perpendicular magnetic recording layer is preferably in the above range is that, when the perpendicular magnetic recording layer is formed, the oxide precipitates around the magnetic grains, and can separate fine magnetic grains. If the oxide content exceeds the above range, the oxide remains in the magnetic grains and damages the orientation and crystallinity of the magnetic grains. Moreover, the oxide precipitates on the upper and lower parts of the magnetic grains, with an undesirable result that the columnar structure, in which the magnetic grains penetrate the perpendicular magnetic recording layer in the thickness direction, is not formed. The oxide content less than the above range is undesirable because the fine magnetic grains are insufficiently separated, resulting in increased noise when information is reproduced, and therefore, a signal-to-noise ratio (SN ratio) suitable to high-density recording is not provided.

The content of Cr in the perpendicular magnetic recording layer is preferably 0 at % or more and 16 at % or less and more preferably 10 at % or more and 14 at % or less. The reason why the content of the Cr is preferably in the above range is that the uniaxial crystal magnetic anisotropic constant Ku of the magnetic grains is not too much reduced and high magnetization is retained, with the result that read/write characteristics suitable to high-density recording and sufficient thermal fluctuation characteristics are provided. The Cr content exceeding the above range is undesirable because Ku of the magnetic grains is lowered, and therefore, the thermal fluctuation characteristics are degraded, and also, the crystallinity and orientation of the magnetic grains are impaired, resulting in deterioration in read/write characteristics.

The content of Pt in the perpendicular magnetic recording layer is preferably 10 at % or more and 25 at % or less. The reason why the content of Pt is preferably in the above range is that the Ku value required for the perpendicular magnetic layer is provided, and further, the crystallinity and orientation of the magnetic grains are improved, with the result that the thermal fluctuation characteristics and read/write characteristics suitable to high-density recording are provided. The Pt content exceeding the above range is undesirable because a layer having an fcc structure is formed in the magnetic grains and there is a risk that the crystallinity and orientation are impaired. The Pt content less than the above range is undesirable because a Ku value satisfactory for the thermal fluctuation characteristics suitable to high-density recording is not provided.

The perpendicular magnetic recording layer may contain one or more types of elements selected from B, Ta, Mo, Cu, Nd, W, Nb, Sm, Tb, Ru and Re besides Co, Cr, Pt and the oxides. When the above elements are contained, formation of fine magnetic grains is promoted or the crystallinity and orientation can be improved and read/write characteristics and thermal fluctuation characteristics suitable to high-density recording can be provided. The total content of the above elements is preferably 8 at % or less. The content exceeding 8 at % is undesirable because phases other than the hcp phase are formed in the magnetic grains and the crystallinity and orientation of the magnetic grains are disturbed, with the result that read/write characteristics and thermal fluctuation characteristics suitable to high-density recording are not provided.

As the perpendicular magnetic recording layer, a CoPt-based alloy, CoCr-based alloy, CoPtCr-based alloy, CoPtO, CoPtCrO, CoPtSi, CoPtCrSi, a multilayer structure of an alloy layer containing at least one type selected from the group consisting of Pt, Pd, Rh and Ru and a Co layer, and materials obtained by adding Cr, B or O to these layers, for example, CoCr/PtCr, CoB/PdB and CoO/RhO may be used.

The thickness of the perpendicular magnetic recording layer is preferably 5 to 60 nm and more preferably 10 to 40 nm. When the thickness is in this range, a magnetic recording apparatus suitable to higher recording density can be manufactured. If the thickness of the perpendicular magnetic recording layer is less than 5 nm, read outputs are too low and noise components tend to be higher. If the thickness of the perpendicular magnetic recording layer exceeds 40 nm, read outputs are too high and the waveform tends to be distorted. The coercivity of the perpendicular magnetic recording layer is preferably 237000 A/m (3000 Oe) or more. If the coercivity is less than 237000 A/m (3000 Oe), thermal fluctuation resistance tends to be degraded. The perpendicular squareness of the perpendicular magnetic recording layer is preferably 0.8 or more. If the perpendicular squareness is less than 0.8, the thermal fluctuation resistance tends to be degraded.

[Adhesion Layer]

The adhesion layer is a layer to adhere a UV curable resin. The adhesion layer preferably comprises a metal selected from Al, Ag, Au, Co, Cr, Cu, Ni, Pd, Pt, Si, Ta, and Ti as a main component, which is durable against O₂ or O₃, and preferably has a thickness of 1 to 15 nm.

[UV Curable Resin]

A UV curable resin (2P agent) is a composition containing a monomer, an oligomer and a polymerization initiator but not a solvent.

Examples of the monomer include those shown below.

Acrylates
Bisphenol A•ethylene oxide-modified diacrylate (BPEDA)
dipentaerythritol hexa(penta)acrylate (DPEHA)
dipentaerythritol monohydroxy pentaacrylate (DPEHPA)
dipropylene glycol diacrylate (DPGDA)
ethoxylated trimethylolpropane triacrylate (ETMPTA)
glycerinpropoxy triacrylate (GPTA)
4-hydroxybutyl acrylate (HBA)
1,6-hexanediol diacrylate (HDDA)
2-hydroxyethyl acrylate (HEA)
2-hydroxypropyl acrylate (HPA)
isobornyl acrylate (IBOA)
polyethylene glycol diacrylate (PEDA)
pentaerythritol triacrylate (PETA)
tetrahydrofurfuryl acrylate (THFA)
trimethylolpropane triacrylate (TMPTA)
tripropylene glycol diacrylate (TPGDA)

Methacrylates
tetraethylene glycol dimethacrylate (4EDMA)
alkyl methacrylate (AKMA)
allyl methacrylate (AMA)
1,3-butylene glycol dimethacrylate (BDMA)
n-butyl methacrylate (BMA)
benzyl methacrylate (BZMA)
cyclohexyl methacrylate (CHMA)
diethylene glycol dimethacrylate (DEGDMA)
2-ethylhexyl methacrylate (EHMA)
glycidyl methacrylate (GMA)
1,6-hexanediol dimethacrylate (HDDMA)
2-hydroxyethyl methacrylate (2-HEMA)
isobornyl methacrylate (IBMA)
lauryl methacrylate (LMA)
phenoxyethyl methacrylate (PEMA)
t-butyl methacrylate (TBMA)
tetrahydrofurfuryl methacrylate (THFMA)
trimethylolpropane trimethacrylate (TMPMA)

In particular, isobornyl acrylate (IBOA), tripropylene glycol diacrylate (TPGDA), 1,6-hexanediol diacrylate (HDDA), dipropylene glycol diacrylate (DPGDA), neopentyl glycol diacrylate (NPDA) and ethoxylated isocyanuric acid triacrylate (TITA) are preferred because these may have viscosity of 10 cP or less.

Examples of the oligomer include urethane acrylate-bases materials such as polyurethane diacrylate (PUDA) and polyurethane hexaacrylate (PUHA), and other examples include polymethyl methacrylate (PMMA), fluorinated polymethyl methacrylate (PMMA-F), polycarbonate diacrylate, and fluorinated polycarbonate methyl methacrylate (PMMA-PC-F).

Examples of the polymerization initiator include IRGACURE 184 (trade name, manufactured by Nihon Ciba-Geigy K.K.) and DAROCURE 1173 (trade name, manufactured by Nihon Ciba-Geigy K.K.).

[Removal of Residues]

Residues remaining at bottoms of recesses of the resist are removed by RIE (reactive ion etching). As a plasma source, ICP (inductively-coupled plasma) capable of forming high density plasma at low pressure is preferred. However, ECR (electron cyclotron resonance) plasma or a general parallel plate RIE apparatus may be used. Residues of the UV curable resin (2P agent) are removed preferably with an oxygen gas.

[Magnetism deactivation and Etching]

When flying characteristics of a read/write head are taken in consideration, a depth of recesses is preferably set at 10 nm or less, while a thickness of a magnetic recording layer needs to be substantially 15 nm for securing signal output. In this connection, if a thickness of 10 nm in the magnetic recording layer with a thickness of 15 nm is physically removed and a remaining thickness of 5 nm is deactivated in magnetism, side erase and side read may be suppressed while securing the flying characteristics of the recording head. This makes it possible to produce DTR media and BPMs. As a method of magnetically deactivating the magnetic recording layer having a thickness of 5 nm, a method of exposing the magnetic recording layer to He or N₂ ions may be used. When the magnetic recording layer is exposed to He ions, while maintaining squareness of a hysteresis loop, Hc (coercivity) decreases with an exposure time to result in losing the hysteresis eventually (magnetism deactivation). In this case, when an exposing time to a He gas is insufficient, the hysteresis excellent in the squareness (having reversal nucleation field Hn) is maintained. However, this means that a magnetic layer at the bottom of the recess has recording capacity, that is, advantages of the DTR medium or BPM are lost. On the other hand, when the magnetic recording layer is exposed to N₂ ions, the squareness of the hysteresis loop is deteriorated with the exposing time to result in losing the hysteresis eventually. In this case, while the Hn deteriorates drastically, the Hc is hard to be reduced. However, if the exposing time of N₂ gas is insufficient, a magnetic layer high in the Hc remains at the bottom of the recess to result in losing the advantages of the DTR medium or BPM. Here, by paying attention to difference in behaviors between the magnetism deactivation caused by He gas and that caused by N₂ gas, a mixed gas of He+N₂ is used, and thereby, while etching the magnetic recording layer, the magnetic recording layer at the bottom of the recesses may efficiently deactivated in magnetism.

[Stripping of Etching Protection Layer]

After the magnetic recording layer is deactivated in magnetism, the etching protection layer of carbon is stripped off. The etching protection layer is readily stripped off by treating with oxygen plasma.

[Surface Protective Film Formation and After-Treatment]

The surface protective film of carbon is desirably formed by CVD from the viewpoint of improving coverage to the protrusions and recesses. However, sputtering or vacuum evaporation may be used. When the CVD method is used, a DLC film containing many sp³-bonded carbons is formed. When a thickness of the surface protective film is less than 2 nm, the coverage deteriorates and, when the thickness of the surface protective film exceeds 10 nm, a magnetic spacing between the head and medium becomes larger to unfavorably deteriorate SNR.

Examples of the lubricant applied to the surface protective film include perfluoropolyether, fluorinated alcohol and fluorinated carboxylic acid.

### EXAMPLES

### Example 1

A DTR medium was manufactured by the method shown in FIGS. 3A, 3B, 3C, 3D, 3E, 3F, 3G, 3H, and 3I. Exposing to the non-ionized hydrogen gas is performed for 30 seconds by conveying a sample to a vacuum chamber that was maintained to a high vacuum of 1.0×10⁻⁴ Pa or less, causing a hydrogen gas to flow at 100 sccm, and setting a chamber pressure to 1 Pa.

The manufactured DTR medium was incorporated into a drive to evaluate an on-track BER (bit error rate), and the detected BER was 10⁻⁷. This means that an error occurs once in 10,000,000 times. In contrast, BER of a DTR medium manufactured by an ordinary method in which exposing to the non-ionized hydrogen gas is not performed was 10⁻⁶. Thus, it was found that exposing to the non-ionized hydrogen gas enables the improvement in BER of about 1 order of magnitude. The drive was operated for 720 hours under a high-temperature, high-humidity (65° C., and a humidity of 80%) environment, but BER was not deteriorated.

Next, existence of oxygen in the DTR medium that was used for the drive evaluation was determined by EELS (electron energy loss spectrum).

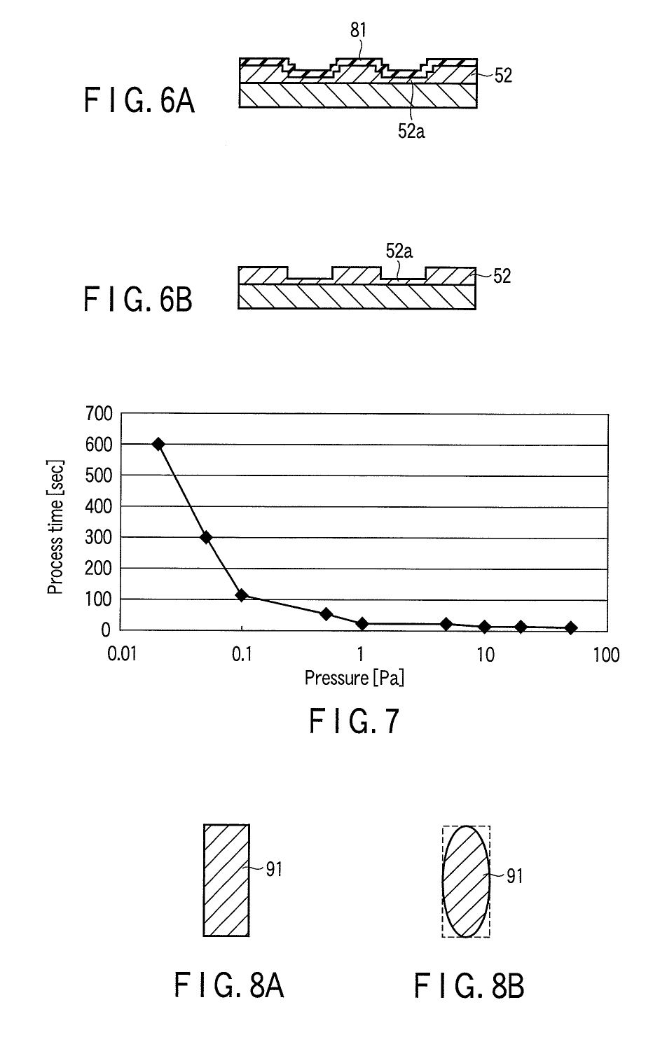

Since oxygen was detected on a surface and a side wall of a magnetic recording layer 52 in a DTR medium manufactured by an ordinary method in which exposing to the non-ionized hydrogen gas was not performed, it was found that an oxygen film 81 was formed on the surface of the magnetic recording layer 52 as shown in FIG. 6A.

Since oxygen was not detected in the DTR medium manufactured by the method of this Example including exposing to the non-ionized hydrogen gas, it was found that an oxygen film was not formed on the surface of the magnetic recording layer 52 as shown in FIG. 6B. The reason for the good BER of the DTR medium manufactured by the method of the embodiment including exposing to the non-ionized hydrogen gas is considered to be prevention of deterioration of magnetic characteristics by elimination of the oxidation damage on the surface of the magnetic recording layer 52.

### Example 2

As conditions for exposing to the non-ionized hydrogen gas, the chamber pressure (process pressure) and the process time were examined.

FIG. 7 shows results of investigation of a time that is required for eliminating an oxygen peak on the magnetic recording layer surface, i.e., a process time for eliminating the oxidation damage, by performing processing under a non-ionized hydrogen gas atmosphere at each of predetermined chamber pressures and by using XPS (X-ray photoelectric spectroscopy).

It was found that process times required for eliminating the oxidation damage at the chamber pressure of 0.02 Pa and a chamber pressure of 1 Pa or higher were 600 seconds and 30 seconds or less, respectively. The results indicate that the oxidation damage elimination effect is high since a hydrogen atom concentration is increased along with an increase in chamber pressure.

As a result of evaluating BER of a drive by incorporating a DTR medium manufactured at a chamber pressure of 0.02 Pa and a process time of 600 seconds, the detected BER was 10^{-6.5}. Since the BER of the DTR medium manufactured by the ordinary method in which exposing to the non-ionized hydrogen gas is not performed was 10⁻⁶, it was found that the BER was improved by about 0.5 order of magnitude. BER of a DTR medium manufactured at a chamber pressure of 0.05 Pa or more and the process time shown in FIG. 7 was 10⁻⁷. It is considered that, when the chamber pressure is 0.02 Pa, the absolute number of hydrogen atoms is small in the chamber to limit penetration of hydrogen into the interior of the magnetic recording layer, thereby preventing reduction in the interior of the magnetic recording layer. In addition, since it is preferable that one step is finished in 5 minutes (300 seconds) or less in view of the mass production, it is preferable to perform exposing to the non-ionized hydrogen gas at a chamber pressure of 0.05 Pa or higher.

On the other hand, it was found that, in the case where exposing to the non-ionized gas was performed at a chamber pressure exceeding 10 Pa, excessive hydrogen atoms adhered to the surface of the magnetic recording layer to increase a bonding ratio of a lubricant to be applied to the surface protective film to be formed in the subsequent step.

Here, the lubricant applied to the surface protective film is divided into a bonding layer that adheres to the surface protective film and a free layer that does not adhere to the surface protective film. A proportion of the bonding layer in a total amount of lubricant is referred to as the bonding ratio. It is indicated that a ratio of the free layer with respect to the total amount of lubricant is reduced along with an increase in bonding ratio. The bonding ratio is represented by a ratio between a film thickness of the lubricant in an initial state as-applied and a film thickness of the lubricant after the free layer is washed away with a solvent.

In an ordinary DTR medium, the bonding ratio within a range of 70% to 80%, for example about 75%, is considered preferable from the viewpoint of reliability. In the case where the bonding ratio is less than 70%, reliability of the drive is lowered since coverage by the lubricant on the medium surface is insufficient due to a large proportion of the free layer and a small proportion of the bonding layer. When the bonding ratio exceeds 80%, the proportion of the free layer with respect to the total amount of lubricant is reduced, so that an amount of the lubricant supplied from another region when the lubricant is eliminated from the medium surface by contact with the head is reduced, thereby lowering reliability of the drive.

A relationship between the chamber pressure in exposing the magnetic recording layer to the non-ionized hydrogen gas and the bonding ratio of the lubricant applied to the surface protective film formed on the magnetic recording layer is such that the bonding ratio is about 75% when the chamber pressure is 10 Pa or less, and the bonding ratio is about 85% when the chamber pressure exceeds 10 Pa. Thus, when the chamber pressure exceeds 10 Pa, the bonding ratio of the lubricant applied to the surface protective film is excessively increased, thereby lowering the reliability of drive.

In view of the results given above, the chamber pressure of exposing to the non-ionized hydrogen gas may preferably be 0.05 Pa or more and 10 Pa or less.

### Example 3

As one of the conditions in exposing to the non-ionized hydrogen gas, the hydrogen gas flow rate was examined.

25 DTR media were manufactured in the same manner as in Example 2 by setting the hydrogen gas flow rate to 1 sccm and the chamber pressure to 0.05 Pa. As a result of examining an oxygen peak of each of the DTR medium surfaces by XPS, the oxygen peak was not detected in all of the 25 media.

25 DTR media were manufactured in the same manner as in Example 2 by adjusting the hydrogen gas flow rate to 0.5 sccm and the chamber pressure to 0.05 Pa. As a result of examining an oxygen peak of each of the DTR medium surfaces by XPS, the oxygen peak was detected in 3 media. It is considered that the oxygen peak is attributable to unstableness of the process. The chamber pressure (process pressure) is controlled by adjusting the hydrogen gas flow rate and an evacuation capacity of a vacuum pump. In order to set the chamber pressure to 0.05 Pa at the hydrogen gas flow rate of less than 1 sccm, it is necessary to reduce the evacuation capacity of the vacuum pump by fine adjustment in a direction of closing a conductance valve, thereby making the atmosphere unstable. Thus, the process becomes unstable when the hydrogen gas flow rate is less than 1 sccm to cause defective products.

25 DTR media were manufactured in the same manner as in Example 2 by setting the hydrogen gas flow rate to more than 200 sccm and the chamber pressure to 0.05 Pa. As a result of examining an oxygen peak of each of the DTR medium surfaces by XPS, the oxygen peak was not detected in all of the 25 media. A bonding ratio of the lubricant applied to the surface protective film was measured to be 85%. As described in Example 2, when the bonding ratio is excessively high, it leads to the lowered reliability, which is not preferable.

In the DTR media manufactured by adjusting the hydrogen gas flow rate to 200 sccm or less and the chamber pressure to 0.05 Pa, a bonding ratio of the lubricant applied to the surface protective film was 75%, which is desirable from the reliability point of view.

In view of the above results, the hydrogen gas flow rate in exposing to the non-ionic hydrogen gas may preferably be 1 sccm or more and 200 sccm or less.

### Example 4

A DTR medium was manufactured by using a forming gas, carbon monoxide (CO), or ammonium (NH₃) in place of the hydrogen gas in exposing to the non-ionized reducing gas.

The manufactured DTR medium was incorporated into a drive to evaluate an on-track BER, and the detected BER was 10⁻⁷. The drive was operated for 720 hours under high-temperature, high-humidity (65° C., and a humidity of 80%) environment, but BER was not deteriorated. Existence of oxygen in the DTR medium used for the drive evaluation was investigated by EELS, but oxygen was not detected. Thus, it was confirmed that, when the forming gas, CO, or NH₃ is used as the reducing gas, it is possible to attain the effect similar to that of using the hydrogen gas.

Since the forming gas is a gas that is obtained by diluting H₂ with N₂ to be the explosion limit or less, in which H₂ concentration is 5% or less, and has high safety, the forming gas is often used as a substitute for the hydrogen gas. However, when the forming gas is used in place of the hydrogen gas in the plasma process described in Japanese Patent No. 4191096, the N₂ gas is also ionized by plasma so that active N₂ ions react with the medium surface, thereby causing damages.

In this Example, since the forming gas is not made into plasma when it is used as the reducing gas, the N₂ gas remaining inert is retained in the process chamber and does not cause damages on the medium surface. Thus, since using the non-ionized reducing gas in this Example allows the use of the forming gas that has been the cause of the problem in the conventional method, this Example is advantageous in safety.

Since CO and NH₃ are toxic, a detoxification device is provided in the manufacturing apparatus in the case of using these reducing gases. Further, since a residual gas on the medium surface is dangerous, washing is performed to completely eliminate the residual gas.

### Example 5

In order to examine durability of the surface protective film on the nonmagnetic layer, a sample was manufactured as described below. In the sample, the nonmagnetic layer of a material prepared by magnetically deactivating the magnetic recording layer is formed on the entire surface of the substrate and without performing patterning of the magnetic recording layer formed on the substrate, and a sliding test using a read/write head was performed. Since the head is frictioned with the surface of the sample in the sliding test, the sliding test is a criterion for evaluating hardness and abrasion resistance of the surface protective film.

The magnetic recording layer was formed on the substrate, followed by irradiation with a He+N₂ mixture gas ion beam for exposure to oxygen plasma in the same manner as in removing the etching protective film. The sample was conveyed into a vacuum chamber kept to 1.0×10⁻⁴ Pa or less and retained for 30 seconds in a state where a hydrogen gas was flowed to the chamber at a flow rate of 100 sccm and a chamber pressure was maintained to 1 Pa. After that, the surface protective film was formed. The sliding test of the manufactured sample was performed to prove that no scratch was generated on the surface of the sample after 720 hours had passed.

For the purpose of comparison, a sample of Comparative Example was manufactured in the same manner as described above except for not performing exposing to the non-ionized hydrogen gas. The sliding test of the manufactured sample of Comparative Example was performed to show that scratches were produced on the surface of the sample after 600 hours had passed.

In an ordinary perpendicular magnetic recording medium, no scratch was produced in the 720-hour sliding test. Since the scratches were produced after 600 hours in the sample of Comparative Example for which exposing to the non-ionized hydrogen gas was not performed after the exposure to He+N₂ mixture gas ion beam, it was confirmed that hardness and abrasion resistance of the surface protective film are relatively inferior. In contrast, since the sample for which exposing to the non-ionized hydrogen gas was performed after the exposure to He+N₂ mixture gas ion beam was capable of enduring the 720-hour sliding test, it was confirmed that deterioration of hardness and abrasion resistance of the surface protective film were suppressed.

In the case of a patterned medium, since the region for which the nonmagnetic layer is formed by exposure to the He+N₂ mixture gas ion beam is the bottom of the recesses of the magnetic recording layer, the read/write head never collides with the surface protection layer formed on the nonmagnetic layer. Thus, it can be mentioned that slight deterioration of film quality of the surface protective film formed on the nonmagnetic layer is not problematic. However, exposing to the non-ionized hydrogen gas is useful for ensuring the reliability in a severe environment of high-temperature and high-humidity.

### Example 6

BPM was manufactured in the same manner as in Example 1. The manufactured BPM had a bit size of 60 nm×20 nm. Since it is impossible to define BER of BPM, signal amplification intensity was examined. When the medium on which a magnetic recording medium was magnetized in one direction was incorporated in a drive and observation of readout waveform was performed, signal amplitude intensity of 200 mV was observed. Positioning accuracy of the read/write head was 6 nm. Thus, it was found that it is also possible to manufacture BPM by the manufacturing method of the embodiment. The manufactured BPM was observed with a MFM (magnetic force microscope), and a rectangular recording bit shown in FIG. 8A was observed.

For the purpose of comparison, BPM was manufactured without performing exposing to the non-ionized hydrogen gas. The manufactured BPM of Comparative Example was observed with a MFM (magnetic force microscope), and an oval recording bit was observed as shown in FIG. 8B. It is considered that, though the shape of the recording bit is physically rectangular, the shape of the magnetic recording bit is seen as oval since magnetism at corners of the recording bit is lost due to oxidation damages.

The oxidation damages of the recording bit are reduced by exposing to the non-ionized hydrogen gas, so that the physical shape and the magnetic shape become identical as shown in FIG. 8A. In other words, it is possible to cancel out the oxidation damages of the recording bit by exposing to the non-ionized hydrogen gas.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of manufacturing a magnetic recording medium, comprising:
forming a magnetic recording layer, an etching protection layer, and an adhesion layer on a substrate;
applying a resist on the adhesion layer;
transferring patterns of protrusions and recesses on the resist by imprinting in order to form a resist pattern;
patterning the adhesion layer by using the resist pattern as a mask;
patterning the etching protection layer by using the resist pattern as a mask;
etching the magnetic recording layer by using patterns of the adhesion layer and the etching protection layer as masks in order to form patterns of protrusions and recesses of the magnetic recording layer and removing the pattern of the adhesion layer;
stripping the pattern of the etching protection layer; and
exposing the patterns of protrusions and recesses of the magnetic recording layer to a non-ionized reducing gas.

2. The method of claim 1, wherein etching the magnetic recording layer by using patterns of the adhesion layer and the etching protection layer as masks is performed with a mixture gas of Helium (He) and Nitrogen (N₂) in such a manner that a part of a thickness of the magnetic recording layer is remained and deactivated in magnetism to be a nonmagnetic layer in the recesses of the magnetic recording layer.

3. The method of claim 1, wherein the reducing gas is selected from the group consisting of hydrogen gas, forming gas, carbon monoxide gas, and ammonium gas.

4. The method of claim 3, wherein exposing the patterns of protrusions and recesses of the magnetic recording layer to the non-ionized reducing gas is performed in hydrogen gas at a pressure of 0.05 Pa or more and 10 Pa or less.

5. The method of claim 1, wherein exposing the patterns of protrusions and recesses of the magnetic recording layer to the non-ionized reducing gas is performed by flowing hydrogen gas at a flow rate of 1 standard cubic centimeters per minute (sccm) or more and 200 sccm or less into a vacuum chamber maintained to a pressure of 1.0×10⁻⁴ Pa or less.

6. The method of claim 1, wherein a surface protective film of carbon is formed after exposing the patterns of protrusions and recesses of the magnetic recording layer to the non-ionized reducing gas.
